(19) United States
(12) Patent Application Publication
(10) Pub. No.: US 2009/0296379 A1
(43) Pub. Date: Dec. 3, 2009

(54) ELEVATED AIRPORT LIGHTS WITH AN ADJUSTMENT MECHANISM

(75) Inventors: Russell Lewis Tartock, Springfield, IL (US); Todd Hanson, Greenfield, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International

(21) Appl. No.: 12/131,635

(22) Filed: Jun. 2, 2008

(51) Int. Cl. F21S 8/00

(52) U.S. Cl. 362/153

(57) ABSTRACT

An elevated airport light for an airport runway light system includes a housing incorporating a light source and a mast mounted to a base plate through a frangible coupling. An adjustment cap is disposed around the mast and designed to thread into a base of the housing. The cap and the housing can exhibit spherical surfaces to capture a ball between the cap and the housing. The spherical surface of the cap can be smooth and intended to slide easily on the ball. Similarly, the spherical surface of the housing can include ribs that are designed to cut into the ball for holding orientation of the housing to the mast while tightening the cap. Therefore, the adjustment cap can enable quick rotational and horizontal adjustment of the light source without the need for fasteners.

### TECHNICAL FIELD

Embodiments are generally related to airport runway light systems and installations. Embodiments are also related to elevated airport and heliport lights for use in airport runway light and heliport touchdown and lift-off (TLOF)/final approach and take-off (FATO) lighting systems. Embodiments are additionally related to adjustment mechanisms utilized in the context of elevated airport lights.

### BACKGROUND OF THE INVENTION

Lighting systems are essential navigational aids for aircrafts, boats, or other vehicles, and in providing guidance, signaling and demarcation functions. Modern airports incorporate numerous specialized elevated lighting systems for illuminating the edge of an airport runway, taxiway and parking areas to minimize the possibility that an aircraft may inadvertently travel off the edge of the runway. Typical elevated lighting systems include, but are not limited to, approach lighting, runway edge lighting, runway end lighting, runway threshold lighting, and taxiway edge lighting systems. The elevated lights in the runway edges can be specially designed to define runways and taxiways and inhibit pilots from inadvertently maneuvering airplanes off a designated runway and/or taxiway.

Elevated lights may include a housing that is attached to a mast. The mast can be firmly fastened via a frangible coupling to a base plate, which is embedded into the surface of the ground. The housing includes a light source, which receives a source of power from a power supply through the mast. The mast projects upward from the frangible coupling in the base plate and supports the light source above the surface of the ground in order to provide the elevated lighting. An electrical plug may be provided at the bottom of the mast to couple the electrical wiring of the light source to a main line of the airport lighting system.

Moreover, the elevated lights may include an adjustment means provided at the junction of the base of the housing and the mast. This adjustment means can be utilized to adjust the longitudinal axis of the housing in order to maintain the housing in a substantially vertical orientation, thereby properly aligning the optical output with the world horizon. The adjustment mechanism allows for rotational adjustment of the housing so that the light output may be properly aligned and oriented with respect to the runway or taxiway. Such an adjustment mechanism also may contribute, however, to an increased chance of misalignment during the installation of the elevated lights due to an inaccurate arrangement of the housing and the mast.

The majority of prior art elevated airport lights utilize a three screw adjustment for securing the assembly following rotational and horizontal positioning of the light source. Some prior art elevated airport lights also utilize a ball and socket design to allow for smoother adjustment of the light source. Such adjustment mechanisms, however, require at least one separate fastener for maintaining the light source in a vertical orientation. The fastener can be easily lost during an adjustment process, which may cause an unnecessary delay in operation, which result in runways being closed longer than necessary. Therefore, it is desirable to provide an adjustment means for easily and rapidly adjusting the light source.

In an effort to address the foregoing difficulties, it is believed that an improved elevated airport light with an adjustment mechanism that enables a quick adjustment of the light source without the need for fasteners can be successfully implemented. It is also believed that the improved elevated light disclosed herein can address these and other continuing needs.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is therefore one aspect of the present invention to provide for an improved elevated airport light for use in airport runway light systems.

It is another aspect of the present invention to provide for an adjustment cap utilized in the context of elevated airport lights.

The aforementioned aspects and other objectives and advantages can now be achieved as described herein. An improved elevated airport light for an airport runway light system comprises a housing incorporating a light source and a mast mounted to a base plate through a frangible coupling. An adjustment cap can be disposed around the mast and designed to thread into a base of the housing. The cap and the housing can exhibit spherical surfaces to capture a ball between the cap and the housing. The spherical surface of the cap can be smooth and intended to slide easily on the ball. Similarly, the spherical surface of the housing can include ribs that are designed to cut into the ball for holding orientation of the housing to the mast while tightening the cap. Therefore, the adjustment cap can enable quick rotational and horizontal adjustment of the light source without the need for fasteners.

Furthermore, a set of adjustment screws can be threaded into the housing. The base of the housing can be designed with a threaded interface to receive the adjustment cap, wherein the spherical surface of the housing can be ribbed, knurled, or otherwise textured. The ball can be fixed to the upper end of the mast. The lower end of the mast can be attached to the frangible coupling. The ball can be comprised of a stiff but ductile material. The housing can be leveled with the adjustment cap partially assembled, so that the ball and the adjustment cap can be secured by the housing. Hence, it is difficult to lose or misplace the components of the elevated airport light.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic cross-sectional view of an elevated airport light with an adjustment cap, in accordance with a preferred embodiment;

FIG. 2 illustrates a top plan view of an airport runway light system incorporating elevated airport lights constructed and arranged in accordance with a preferred embodiment; and

FIG. 3 illustrates a top plan view of a heliport landing area lighting system incorporating elevated airport lights constructed and arranged in accordance with an alternative embodiment.

### DETAILED DESCRIPTION

The particular values and configurations discussed in these non-limiting examples can be varied and are cited merely to illustrate at least one embodiment and are not intended to limit the scope thereof.

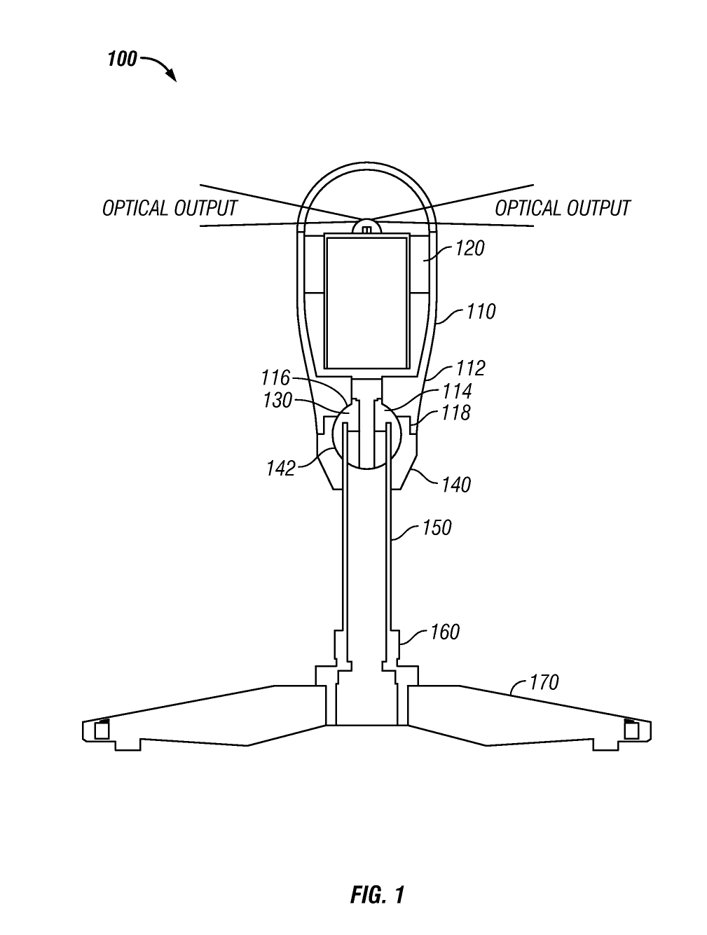

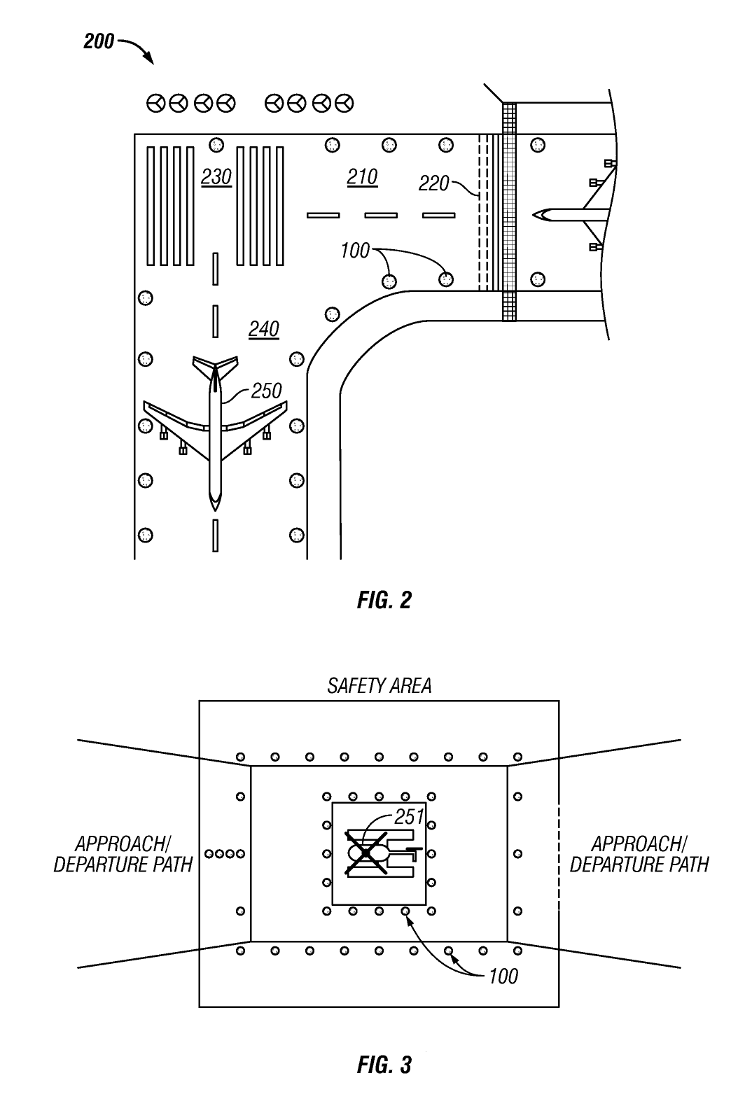

FIG. 1 illustrates a schematic cross-sectional view of an elevated airport light 100 with an adjustment cap 140, in accordance with a preferred embodiment. Note that as utilized herein the term “airport” can refer not just to an airport, but also a heliport or other launch and landing facilities. The elevated airport light 100 generally includes a housing 110 elevated above the surface of ground by utilizing a mast 150. The housing 110 can incorporate a light source 120 that is secured at the mast 150 with the help of adjustment cap 140. The mast 150 can be mounted to a base plate 170 through a frangible coupling 160. Note that the embodiments discussed herein generally relate to airport runway light systems 200, as illustrated in FIG. 2. It can be appreciated, however, that such embodiments can be implemented in the context of other lighting systems and designs and are not limited to the airport runway light system 200. The discussion of airport runway light systems 200, as utilized herein, is presented for general illustrative purposes only.

The mast 150 and the base plate 170 can provide a source of power through a power coupler (not shown) by utilizing a set of electrical wires (not shown). The mast 150 can be designed as hollow to allow the electrical wires between the light source 120 in the housing 110 and the base plate 170. The power coupler can further be connected with a main power line (not shown) in the airport runway light system 200. Such a power coupler can provide the required power to the light source 120 via the mast 150. The mast 150 secures to the base plate 170 via the frangible coupling 160 to provide a stable support for the housing 110 during harsh weather conditions or other conditions impacting operation and/or orientation of the elevated airport light 100. The frangible coupling 160 enables an easy breakaway of the mast 150 from the base plate 170 when an airplane 250, as illustrated in FIG. 2, maintenance vehicle, or other forces exert a predetermined pressure on the frangible coupling 160 sufficient to cause breaking thereof.

Moreover, the housing 110, the mast 150 and the base plate 170 can be arranged in a substantially vertical alignment. The adjustment cap 140 can be provided at the junction of a base 112 of the housing 110 and the mast 150 so that the longitudinal axis of the housing 110 can be adjusted to be maintained in a substantially vertical orientation and the housing 110 may be rotated about its longitudinal axis so as to align it with the runway 240 or taxiway 210. The adjustment cap 140 can be tightened to hold the light source 120 at the desired height and angle. Such an adjustment cap 140 can be disposed around the mast 150 and designed to thread into the base 112 of the housing 110. The adjustment cap 140 can be threaded to a threaded interface 118 located at the base 112 of the housing 110.

In addition, a set of adjustment screws (not shown) can also be threaded into the housing 110 in order to enable positioning of the light source 120 within the housing 110. The adjustment cap 140 and the housing 110 can exhibit spherical surfaces 114 and 142 to capture a ball 130 between the cap 140 and the housing 110. The ball 130 can be fixed to the upper end of the mast 150 where the lower end of the mast 150 can be attached to the frangible coupling 160. The ball 130 can be comprised of a stiff but ductile material. The spherical surface 142 of the cap 140 can be smooth and intended to slide easily on the ball 130.

Similarly, the spherical surface 114 of the housing 110 can incorporate a set of ribs 116, (i.e. the spherical surface 114 of the housing 110 can be ribbed, knurled, or otherwise textured). The housing 110 can be leveled with the adjustment cap 140 partially assembled, so that the ball 130 and the adjustment cap 140 can be secured by the housing 110. The ribs 116 of the housing 110 can be designed to cut into the ball 130 for holding the orientation of the housing 110 to the mast 150 while tightening the cap 140. Hence, it is difficult to loose or misplace the components of the elevated airport light 100. Therefore, the adjustment cap 140 can enable quick rotational and horizontal adjustment of the light source 120 without the need for fasteners, which avoids unnecessary delays in the operation during adjustment process.

FIG. 2 illustrates a top plan view of an airport runway light system 200 incorporating elevated airport lights 100 constructed and arranged in accordance with a preferred embodiment. Note that in FIGS. 1-2 identical parts or elements are generally indicated by identical reference numerals. The elevated airport lights 100 can be installed on a side of a runway 240 or taxiway 210 and/or near to a hold line 220 for a runway entrance control at a controlled or uncontrolled airfield. These elevated airport lights 100 can provide a clear illumination to the runway 240 or taxiway 210, or an intersection 230 of the runway 240 with another runway 240 or taxiway 210. The elevated airport lights 100 can also guide pilots to drive airplanes 250 in the runways/taxiways 240 and 210 after reaching a runway holding position identified by the hold line 220. The elevated airport lights 100 can be secured to the in-ground mounting base (not shown) via the base plate 170 and electrically coupled to electrical systems (not shown) of the airport runway light system 200.

FIG. 3 illustrates a top plan view of a heliport landing area lighting system incorporating elevated airport lights constructed and arranged in accordance with an alternative embodiment. Note that in FIGS. 1-3, identical or similar parts or elements are generally indicated by identical reference numerals. In the configuration depicted in FIG. 3, rather than an airport runway and airplane as indicated in FIGS. 1-2, the present invention can be embodied in the context of a heliport landing area lighting system for guiding a helicopter 251 along an appropriate approach/departure path to an appropriate landing point. A number of elevated airport lights 100 can be implemented within the context of the design depicted in FIG. 3. The elevated airport/heliport light apparatus 100 can thus be implemented in association with a number of runway light and heliport touchdown and lift-off (TLOF)/final approach and take-off (FATO) lighting systems.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An elevated airport light apparatus, comprising:
a housing incorporating at least one light source for producing light, wherein said housing includes a spherical recess with a plurality of ribs;
a mast mounted to a base plate through a frangible coupling to elevate said at least one light source above a surface of ground, and a bail fixed to an upper end of said mast, wherein said plurality of ribs of said housing is designed to cut into said ball; and
an adjustment cap disposed around said mast and said housing in order to capture said ball between said adjustment cap and said housing, wherein said plurality of ribs of said housing holds orientation of said housing to said mast by tightening said adjustment cap, thereby facilitating a quick rotational and horizontal adjustment of said at least one light source without utilizing an additional fastener.

2. The apparatus of claim 1 wherein said adjustment cap is threadable into a base of said housing.

3. The apparatus of claim 1 wherein said adjustment cap comprises a spherical surface that is smooth and intended to slide on said ball.

4. The apparatus of claim 1 wherein said ball is comprised of a stiff and ductile material.

5. The apparatus of claim 1 wherein said housing is leveled with said adjustment cap partially assembled, so that said ball and said adjustment cap are secured by said housing.

6. The apparatus of claim 1 wherein said frangible coupling is attached at a lower end of said mast.

7. The apparatus of claim 1 wherein said housing, said mast and said adjustment cap are arranged in a substantially vertical alignment.

8. The apparatus of claim 1 wherein said base of said housing comprises a threaded interface to receive said adjustment cap.

9. An elevated airport light apparatus, comprising:
a housing incorporating at least one light source for producing light, wherein said housing includes a spherical recess with a plurality of ribs;
a mast mounted to a base plate through a frangible coupling to elevate said at least one light source above a surface of ground, and a ball fixed to an upper end of said mast, wherein said plurality of ribs of said housing is designed to cut into said ball; and
an adjustment cap disposed around said mast and said housing in order to capture said ball between said adjustment cap and said housing, wherein said plurality of ribs of said housing holds orientation of said housing to said mast by tightening said adjustment cap, thereby facilitating a quick rotational and horizontal adjustment of said at least one light source without utilizing an additional fastener, and wherein said adjustment cap is threadable into a base of said housing.

10. The apparatus of claim 9 wherein said adjustment cap comprises a spherical surface that is smooth and intended to slide on said ball.

11. The apparatus of claim 9 wherein said ball is comprised of a stiff and ductile material.

12. The apparatus of claim 9 wherein said housing is leveled with said adjustment cap partially assembled, so that said ball and said adjustment cap are secured by said housing.

13. The apparatus of claim 9 wherein said frangible coupling is attached at a lower end of said mast.

14. The apparatus of claim 9 wherein said housing, said mast and said adjustment cap are arranged in a substantially vertical alignment.

15. The apparatus of claim 9 wherein said base of said housing comprises a threaded interface to receive said adjustment cap.

16. An method for configuring an elevated airport light, comprising:
incorporating at least one light source for producing light into a housing, wherein said housing includes a spherical recess with a plurality of ribs;
mounting a mast to a base plate through a frangible coupling to elevate said at least one light source above a surface of ground;
fixing a ball to an upper end of said mast, wherein said plurality of ribs of said housing is designed to cut into said ball; and
disposing an adjustment cap around said mast and said housing in order to capture said ball between said adjustment cap and said housing, wherein said plurality of ribs of said housing holds orientation of said housing to said mast by tightening said adjustment cap, thereby facilitating a quick rotational and horizontal adjustment of said at least one light source without utilizing an additional fastener.

17. The method of claim 16 further comprising configuring said adjustment cap to be threadable into a base of said housing.

18. The method of claim 16 further comprising configuring said adjustment cap to comprise a spherical surface that is smooth and intended to slide on said ball.

19. The method of claim 16 wherein said housing is leveled with said adjustment cap partially assembled, so that said ball and said adjustment cap are secured by said housing.

20. The method of claim 16 further comprising arranging said housing, said mast and said adjustment cap in a substantially vertical alignment.
